(19) United States
(12) Patent Application Publication
(10) Pub. No.: US 2010/0066716 A1
(43) Pub. Date: Mar. 18, 2010

(54) Thin display device and method for controlling display content of electronic paper

(75) Inventor: Matthieu GERARD-GODDET, Taoyuan County (TW)

Correspondence Address: STEPTOE & JOHNSON LLP, 1330 CONNECTICUT AVENUE, N.W., WASHINGTON, DC, 20036, US

(73) Assignee: MITAC INTERNATIONAL CORP., Hsinchu (TW)

(21) Appl. No.: 12/557,729

(22) Filed: Sep. 11, 2009

(30) Foreign Application Priority Data
Sep. 12, 2008 (TW) 097135118

(51) Int. Cl. G06F 3/038

(52) U.S. Cl. 345/211

(57) ABSTRACT

A thin display device includes: an electronic paper having a display face, and a back face opposite to the display face; a flexure detector disposed on the back face of the electronic paper for detecting flexing of the electronic paper and generating a corresponding electronic signal; and a processing unit coupled electrically to the electronic paper and the flexure detector, for controlling display content of the display face of the electronic paper based on the electronic signal. By taking advantage of the flexibility of the electronic paper, a user is able to intuitively upscale and downscale the display content of the electronic paper through flexing the electronic paper.

### CROSS-REFERENCE TO RELATED APPLICATION

This application claims priority of Taiwanese application no. 097135118, filed on Sep. 12, 2008.

### BACKGROUND OF THE INVENTION

1. Field of the Invention

The invention relates to a thin display device and a method for controlling display content of an electronic paper, more particularly to a thin display device and a method for controlling display content of an electronic paper based on flexing of the electronic paper.

2. Description of the Related Art

Since the 1970s, scientists have researched electronic paper as a potential substitute for conventional paper. In contrast to the conventional paper, the electronic paper is more convenient to read. Moreover, since the electronic paper is rewritable, use of the electronic paper can contribute to environmental protection efforts.

The electronic paper is an ultra-thin and ultra-light display panel having a display surface on which electronic ink is applied. The electronic ink is composed of numerous tiny transparent capsules containing particles and dye, which can be adjusted so as to present vivid colors and patterns on the display surface.

Certain methods can be used to retain colors and patterns displayed on the electronic paper when power is no longer supplied. Moreover, in contrast to a liquid crystal display panel, the electronic paper can continue to display a distinct image despite being flexed or touched. Such advantages make the electronic paper suitable for a wide variety of uses. For example, newspapers and magazines can be replaced by the electronic paper, and newspaper and magazine publishers can then transmit content to the electronic paper in real time via wireless transmissions from a computer or another device. This not only improves the timeliness and ease of information transmission, but also protects the environment through reducing consumption of the conventional paper.

However, attracting consumers to this relatively new, environmentally friendly product remains a critical challenge. One way of enhancing the appeal of the electronic paper is to design an input interface for controlling display content of the electronic paper, wherein a design of the input interface requires no alteration of the characteristic thinness and lightness of the electronic paper.

### SUMMARY OF THE INVENTION

Therefore, an object of the present invention is to provide a thin display device that controls display content of an electronic paper based on flexing of the electronic paper.

According to one aspect of the present invention, there is provided a thin display device comprising an electronic paper, a flexure detector, and a processing unit. The electronic paper has a display face, and a back face opposite to the display face. The flexure detector is disposed on the back face of the electronic paper for detecting flexing of the electronic paper and generating a corresponding electronic signal. The processing unit is coupled electrically to the electronic paper and the flexure detector, for controlling display content of the display face of the electronic paper based on the electronic signal.

Preferably, the processing unit downscales and upscales the display content of the display face of the electronic paper based on the electronic signal.

Another object of the present invention is to provide a method for controlling display content of an electronic paper based on flexing of the electronic paper.

According to another aspect of the present invention, there is provided a method for controlling display content of an electronic paper, the method comprising the steps of:
a) detecting flexing of the electronic paper and generating a corresponding detection result;
b) controlling the display content of the electronic paper based on the detection result.

Preferably, the display content of the electronic paper is controlled to be upscaled or downscaled based on the detection result.

The present invention takes advantage of the flexibility of an electronic paper to enable a user to intuitively upscale and downscale display content of the electronic paper through flexing the electronic paper.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic diagram of a display face of a first preferred embodiment of a thin display device according to the present invention;

FIG. 2 is a schematic diagram of a back face of the first preferred embodiment;

FIG. 3 is a perspective view for illustrating an electronic paper of the first preferred embodiment when flexed such that a central portion of the display face bulges;

FIG. 4 is a perspective view for illustrating the electronic paper of the first preferred embodiment when flexed such that the central portion of the display face is depressed;

FIG. 5 is a flowchart of a first preferred embodiment of a method for controlling display content of an electronic paper according to the present invention;

FIG. 6 is a schematic diagram of a back face of a second preferred embodiment of a thin display device according to the present invention;

FIG. 7 is a schematic diagram for illustrating a corner of an electronic paper of the second preferred embodiment when flexed toward the back face of the electronic paper;

FIG. 8 is a schematic diagram for illustrating the corner of the electronic paper of the second preferred embodiment when flexed toward a display face of the electronic paper; and

FIG. 9 is a flowchart of a second preferred embodiment of a method for controlling display content of an electronic paper according to the present invention.

### DETAILED DESCRIPTION OF THE PREFERRED EMBODIMENTS

Before the present invention is described in greater detail with reference to the accompanying preferred embodiments, it should be noted herein that like elements are denoted by the same reference numerals throughout the disclosure.

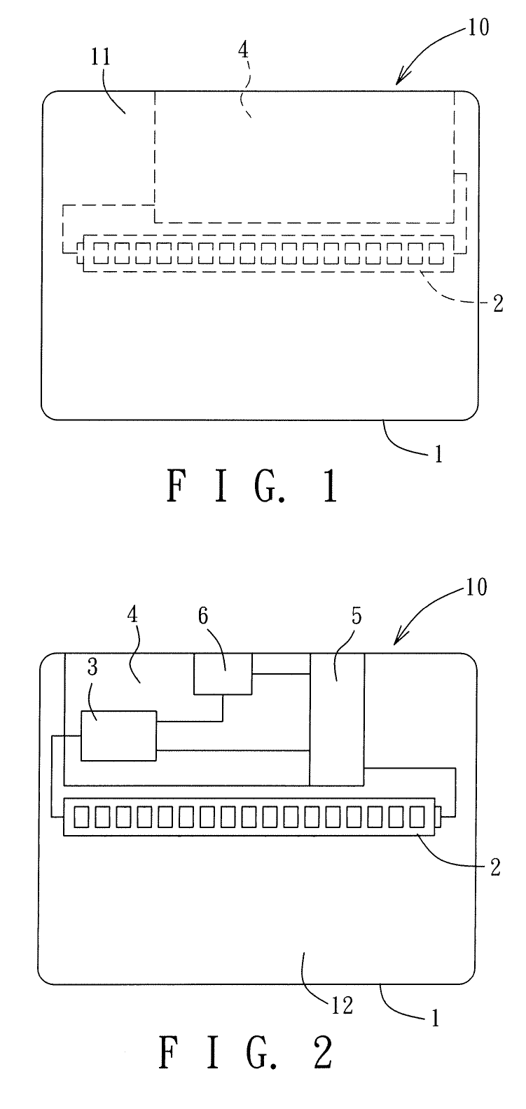

FIGS. 1 and 2 illustrate top and bottom views of the first preferred embodiment of a thin display device 10 according to the present invention, respectively. The thin display device 10 comprises: an electronic paper 1 having a display face 11, and a back face 12 opposite to the display face 11; a flexure detector 2 disposed on the back face 12 of the electronic paper 1; a flexible circuit board 4 disposed on the back face 12 of the electronic paper 1; a processing unit 3 disposed on the flexible circuit board 4 and coupled electrically to the flexure detector 2 and the electronic paper 1; and a power supply unit 5 disposed on the flexible circuit board 4 and coupled electrically to the electronic paper 1, the flexure detector 2 and the processing unit 3, for supplying power thereto. In this embodiment, the power supply unit 5 supplies power to all power-consuming components in the thin display device 10, including the electronic paper 1, the flexure detector 2 and the processing unit 3. In practice, the power supply unit 5 can be a small battery or another type of power supplying element, and is not limited to what is disclosed herein.

The flexure detector 2 detects flexing of the electronic paper 1 and generates a corresponding electronic signal. In this embodiment, the flexure detector 2 has a resistance value that varies when the flexure detector 2 is flexed, and the electronic signal has an electrical current value that varies in inverse proportion to the resistance value of the flexure detector 2. However, this embodiment and the associated Figures should not be imposed as an implementation limitation. Any flexure detector having a measurable value that varies when the flexure detector is flexed can be used.

In this embodiment, the flexible circuit board 4 (a flexible printed circuit board, or FPCB) is used in order to conform with the flexibility of the electronic paper 1. The flexible circuit board 4 thus neither poses an impediment to flexing of the electronic paper 1, nor suffers damage as a result of flexing of the electronic paper 1.

The processing unit 3 is for controlling display content of the display face 11 of the electronic paper 1 based on the electronic signal. In this embodiment, the processing unit 3 is an IC chip (also known as a microchip CPU card) that has computing and storing functionalities, and that downscales and upscales the display content of the electronic paper 1 based on the electronic signal. More particularly, the processing unit 3 downscales or upscales the display content of the electronic paper 1 in response to variation in the electrical current value of the electronic signal that occurs when the flexure detector 2 detects flexing of the electronic paper 1.

Preferably, the thin display device 10 further comprises a data transmission unit 6. In this embodiment, the data transmission unit 6 is a USB interface through which the processing unit 3 can receive image or text information for subsequent display on the electronic paper 1. In practice, the data transmission unit 6 is not limited to a USB interface. For example, a radio frequency circuit with an antenna can serve as the data transmission unit.

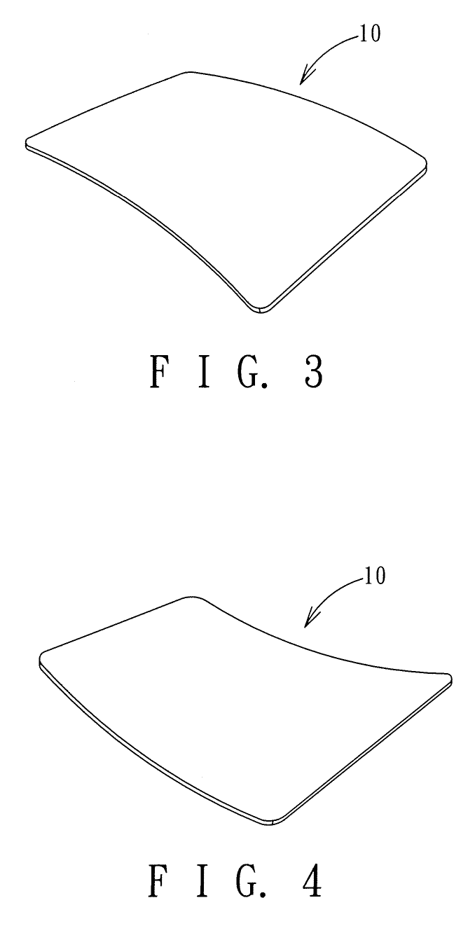

Referring to FIGS. 3 and 4, in this embodiment, the flexure detector 2 is strip-shaped and is disposed at a center part of the back face 12 of the electronic paper 1. When the electronic paper 1 is flexed such that a central portion of the display face 11 bulges, as shown in FIG. 3, the resistance value of the flexure detector 2 increases so that the electrical current value of the electronic signal that is outputted to the processing unit 3 decreases, and the processing unit 3 upscales the display content of the display face 11 of the electronic paper 1 in response to the decrease in the electrical current value of the electronic signal. On the other hand, when the electronic paper 1 is flexed such that the central portion of the display face 11 is depressed, as shown in FIG. 4, the resistance value of the flexure detector 2 decreases so that the electrical current value of the electronic signal that is outputted to the processing unit 3 increases, and the processing unit 3 downscales the display content of the display face 11 of the electronic paper 1 in response to the increase in the electrical current value of the electronic signal.

In this embodiment, each time the flexure detector 2 detects flexing of the electronic paper 1, the electrical current value of the electronic signal that is outputted to the processing unit 3 varies, and the processing unit 3 correspondingly downscales or upscales the display content of the display face 11 of the electronic paper 1 by a scaling factor in response to the variation in the electrical current value of the electronic signal. That is, whenever a user flexes the electronic paper 1, the display content of the display face 11 of the electronic paper 1 is upscaled or downscaled by a preset scaling factor, such that the user can flex the electronic paper 1 as many times as necessary to achieve a desired scaling result.

In view of the foregoing, it should be noted that in this embodiment, variation in the electrical current value of the electronic signal indicates flexing of the electronic paper 1 and the manner in which the electronic paper 1 is flexed, that is, whether the central portion of the display face 11 bulges or is depressed.

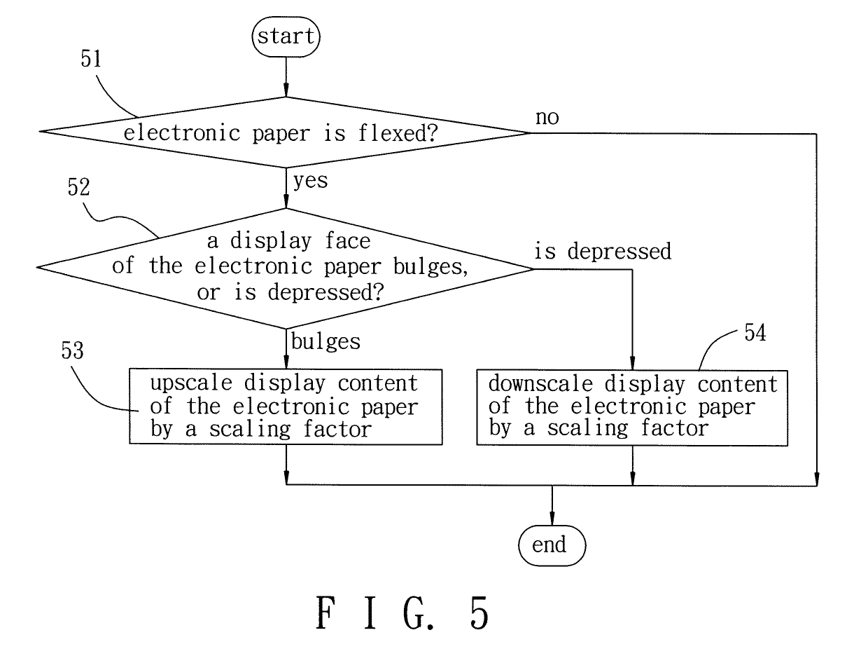

FIG. 5 illustrates a first preferred embodiment of the method for controlling display content of an electronic paper. The method comprises the following steps.

In step 51, the flexure detector 2, which in this embodiment is disposed at the center part of the back face 12 of the electronic paper 1 as shown in FIG. 1, detects flexing of the central portion of the electronic paper 1 by the user in the manners shown in FIGS. 3 and 4 and generates the corresponding electronic signal. The processing unit 3 determines whether the electrical current value of the electronic signal indicates that the electronic paper 1 is flexed. When it is determined on account of variation in the electrical current value that the electronic paper 1 is flexed, the flow proceeds to step 52. Otherwise, the flow terminates, and the processing unit 3 performs no scaling on the display content of the electronic paper 1.

In step 52, the processing unit 3 determines whether the variation in the electrical current value of the electronic signal indicates that the electronic paper 1 is flexed such that the central portion of the display face 11 of the electronic paper 1 bulges, or such that the central portion of the display face 11 is depressed. When it is determined that the variation in the electrical current value indicates that the electronic paper 1 is flexed such that the central portion of the display face 11 of the electronic paper 1 bulges, the flow proceeds to step 53. Otherwise, the flow proceeds to step 54.

In step 53, the processing unit 3 upscales the display content of the electronic paper 1 by a preset scaling factor.

In step 54, the processing unit 3 downscales the display content of the electronic paper 1 by the preset scaling factor.

If the user is not satisfied with the scaling result, steps 51, 52 and 53 can be repeated to continue upscaling, or steps 51, 52 and 54 can be repeated to continue downscaling.

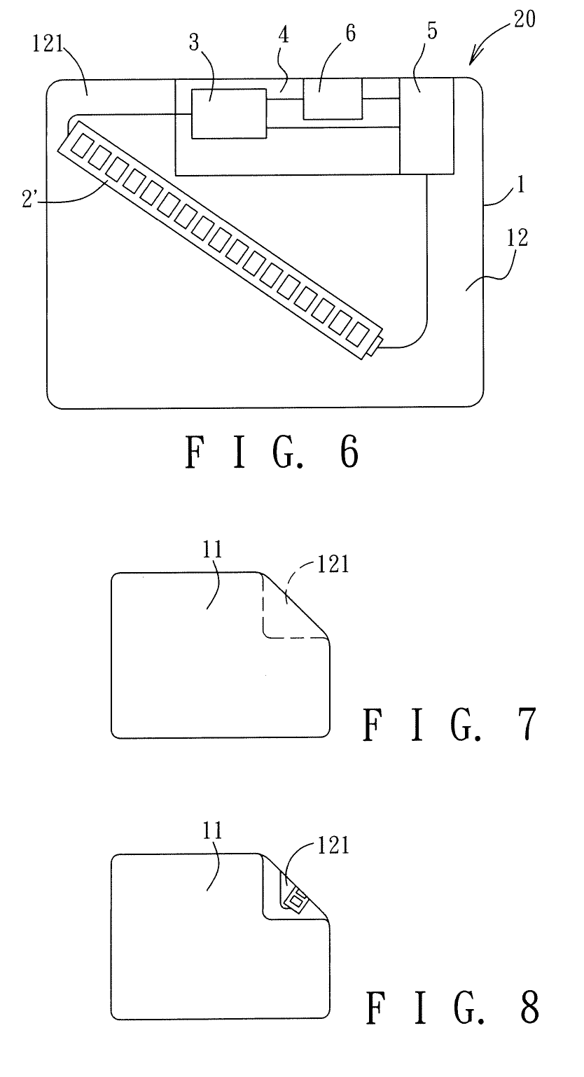

FIG. 6 illustrates a back face 12 of the second preferred embodiment of a thin display device 20 according to the present invention. The second preferred embodiment differs from the first preferred embodiment in that the flexure detector 2′ is disposed at a corner 121 of the back face 12 of the electronic paper 1 and extends diagonally toward a center part of the back face 12. When the corner 121 is flexed toward the back face 12 (that is, backward), as shown in FIG. 7, the resistance value of the flexure detector 2′ increases so that the electrical current value of the electronic signal that is outputted to the processing unit 3 decreases, and the processing unit 3 upscales the display content of the display face 11 of the electronic paper 1 in response to the decrease in the electrical current value of the electronic signal. On the other hand, when the corner 121 is flexed toward the display face 11 (that is, forward), as shown in FIG. 8, the resistance value of the flexure detector 2′ decreases so that the electrical current value of the electronic signal that is outputted to the processing unit 3 increases, and the processing unit 3 downscales the display content of the display face 11 of the electronic paper 1 in response to the increase in the electrical current value of the electronic signal.

Another difference between the second preferred embodiment and the first preferred embodiment lies in that the resistance value of the flexure detector 2′ varies in accordance with increase or decrease of a curvature of the electronic paper 1 so that the electrical current value of the electronic signal that is outputted to the processing unit 3 decreases or increases correspondingly and respectively, and the processing unit 3 upscales or downscales correspondingly the display content of the display face 11 of the electronic paper 1 by a scaling factor corresponding to variation in the electrical current value of the electronic signal. That is, as the curvature formed through forward or backward flexing of the corner 121 of the electronic paper 1 increases or decreases, the scaling factor by which the display content of the display face 11 is scaled increases or decreases correspondingly and respectively.

In view of the foregoing, it should be noted that in this embodiment, variation in the electrical current value of the electronic signal indicates flexing of the electronic paper 1, the manner in which the electronic paper 1 is flexed (that is, whether the corner 121 of the electronic paper 1 is flexed toward the back face 12 of the electronic paper 1, or toward the display face 11 of the electronic paper 1), and the curvature of the electronic paper 1.

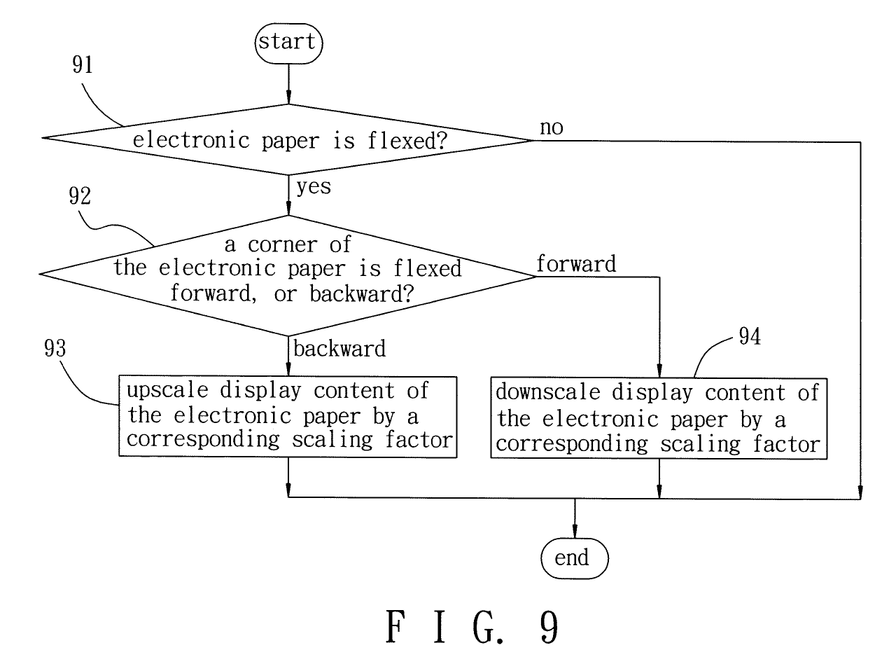

FIG. 9 illustrates the second preferred embodiment of the method for controlling display content of an electronic paper. The method comprises the following steps.

In step 91, the flexure detector 2′, which in this embodiment is disposed at the corner 121 of the electronic paper 1 as shown in FIG. 6, detects flexing of the corner 121 of the electronic paper 1 by the user in the manners shown in FIGS. 7 and 8, and generates the corresponding electronic signal. The processing unit 3 determines whether the electrical current value of the electronic signal indicates that the electronic paper 1 is flexed. When it is determined on account of variation in the electrical current value that the electronic paper 1 is flexed, the flow proceeds to step 92. Otherwise, the flow terminates, and the processing unit 3 performs no scaling on the display content of the electronic paper 1.

In step 92, the processing unit 3 determines whether the variation in the electrical current value of the electronic signal indicates that the corner 121 of the electronic paper 1 is flexed toward the back face 12 of the electronic paper 1, or toward the display face 11 of the electronic paper 1. When it is determined that the variation in the electrical current value indicates that the corner 121 of the electronic paper 1 is flexed toward the back face 12 of the electronic paper 1, the flow proceeds to step 93. Otherwise, the flow proceeds to step 94.

In step 93, the processing unit 3 upscales the display content of the electronic paper 1 by a scaling factor corresponding to the curvature of the electronic paper 1 that is indicated by the variation in the electrical current value of the electronic signal.

In step 94, the processing unit 3 downscales the display content of the electronic paper 1 by a scaling factor corresponding to the curvature of the electronic paper 1 that is indicated by the variation in the electrical current value of the electronic signal.

As in the first preferred embodiment, if the user is not satisfied with the scaling result, steps 91, 92 and 93 can be repeated to continue upscaling, or steps 91, 92 and 94 can be repeated to continue downscaling.

In sum, the present invention takes advantage of the flexibility of the electronic paper 1, enabling the user to upscale and downscale intuitively the display content of the electronic paper 1 through flexing the electronic paper 1.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A thin display device comprising:
an electronic paper having a display face, and a back face opposite to said display face;
a flexure detector disposed on said back face of said electronic paper for detecting flexing of said electronic paper and generating a corresponding electronic signal; and
a processing unit coupled electrically to said electronic paper and said flexure detector, for controlling display content of said display face of said electronic paper based on said electronic signal.

2. The thin display device as claimed in claim 1, further comprising a flexible circuit board disposed on said back face of said electronic paper, said processing unit being disposed on said flexible circuit board.

3. The thin display device as claimed in claim 2, further comprising a power supply unit disposed on said flexible circuit board and coupled electrically to said electronic paper, said flexure detector and said processing unit, for supplying power thereto.

4. The thin display device as claimed in claim 1, further comprising a power supply unit coupled electrically to said electronic paper, said flexure detector and said processing unit, for supplying power thereto.

5. The thin display device as claimed in claim 1, wherein said processing unit is a microchip.

6. The thin display device as claimed in claim 5, wherein said processing unit downscales and upscales the display content of said display face of said electronic paper based on said electronic signal.

7. The thin display device as claimed in claim 1, wherein said flexure detector has a resistance value that varies when said flexure detector is flexed, and said electronic signal has an electrical current value that varies in inverse proportion to the resistance value of said flexure detector.

8. The thin display device as claimed in claim 7, wherein said flexure detector is strip-shaped and is disposed at a center part of said back face of said electronic paper, and wherein,
when said electronic paper is flexed such that a central portion of said display face bulges, the resistance value of said flexure detector increases so that the electrical current value of said electronic signal that is outputted to said processing unit decreases, said processing unit being configured to upscale the display content of said display face of said electronic paper in response to the decrease in the electrical current value of said electronic signal, and
when said electronic paper is flexed such that said central portion of said display face is depressed, the resistance value of said flexure detector decreases so that the electrical current value of said electronic signal that is outputted to said processing unit increases, said processing unit being configured to downscale the display content of said display face of said electronic paper in response to the increase in the electrical current value of said electronic signal.

9. The thin display device as claimed in claim 8, wherein, each time said flexure detector detects flexing of said electronic paper, the electrical current value of said electronic signal that is outputted to said processing unit varies, and said processing unit is configured to correspondingly downscale or upscale the display content of said display face of said electronic paper by a scaling factor in response to the variation in the electrical current value of said electronic signal.

10. The thin display device as claimed in claim 8, wherein the resistance value of said flexure detector varies in accordance with increase or decrease of a curvature of said electronic paper so that the electrical current value of said electronic signal that is outputted to said processing unit decreases or increases correspondingly and respectively, said processing unit being configured to upscale or downscale correspondingly the display content of said display face of said electronic paper by a scaling factor corresponding to a variation in the electrical current value of said electronic signal.

11. The thin display device as claimed in claim 7, wherein said flexure detector is disposed at a corner of said back face of said electronic paper, and wherein,
when said corner is flexed toward said back face, the resistance value of said flexure detector increases so that the electrical current value of said electronic signal that is outputted to said processing unit decreases, said processing unit being configured to upscale the display content of said display face of said electronic paper in response to the decrease in the electrical current value of said electronic signal, and
when said corner is flexed toward said display face, the resistance value of said flexure detector decreases so that the electrical current value of said electronic signal that is outputted to said processing unit increases, said processing unit being configured to downscale the display content of said display face of said electronic paper in response to the increase in the electrical current value of said electronic signal.

12. The thin display device as claimed in claim 11, wherein, each time said flexure detector detects flexing of said electronic paper, the electrical current value of said electronic signal that is outputted to said processing unit varies, and said processing unit is configured to correspondingly downscale or upscale the display content of said display face of said electronic paper by a scaling factor in response to the variation in the electrical current value of said electronic signal.

13. The thin display device as claimed in claim 11, wherein the resistance value of said flexure detector varies in accordance with increase or decrease of a curvature of said electronic paper so that the electrical current value of said electronic signal that is outputted to said processing unit decreases or increases correspondingly and respectively, said processing unit being configured to upscale or downscale correspondingly the display content of said display face of said electronic paper by a scaling factor corresponding to a variation in the electrical current value of said electronic signal.

14. A method for controlling display content of an electronic paper, said method comprising the steps of:
a) detecting flexing of the electronic paper and generating a corresponding detection result;
b) controlling the display content of the electronic paper based on the detection result.

15. The method for controlling display content of an electronic paper as claimed in claim 14, wherein, in step b), the display content of the electronic paper is controlled to be upscaled or downscaled based on the detection result.

16. The method for controlling display content of an electronic paper as claimed in claim 15, wherein, in step b),
when the detection result indicates that the electronic paper is flexed such that a central portion of a display face of the electronic paper bulges, the display content of the electronic paper is upscaled, and
when the detection result indicates that the electronic paper is flexed such that the central portion of the display face is depressed, the display content of the electronic paper is downscaled.

17. The method for controlling display content of an electronic paper as claimed in claim 16, wherein, in step b), each time the detection result indicates that the electronic paper is flexed, the display content of the electronic paper is upscaled or downscaled correspondingly by a scaling factor.

18. The method for controlling display content of an electronic paper as claimed in claim 16, wherein, in step b), the display content of the electronic paper is upscaled or downscaled by a scaling factor corresponding to a curvature of the electronic paper that is reflected in the detection result.

19. The method for controlling display content of an electronic paper as claimed in claim 15, wherein, in step b),
when the detection result indicates that a corner of the electronic paper is flexed toward a back face of the electronic paper, the display content of the electronic paper is upscaled, and
when the detection result indicates that the corner is flexed toward a display face of the electronic paper, the display content of the electronic paper is downscaled.

20. The method for controlling display content of an electronic paper as claimed in claim 19, wherein, in step b), each time the detection result indicates that the electronic paper is flexed, the display content of the electronic paper is upscaled or downscaled correspondingly by a scaling factor.

21. The method for controlling display content of an electronic paper as claimed in claim 19, wherein, in step b), the display content of the electronic paper is upscaled or downscaled by a scaling factor corresponding to a curvature of the electronic paper that is reflected in the detection result.
